(19) United States
(12) Patent Application Publication
(10) Pub. No.: US 2012/0255884 A1
(43) Pub. Date: Oct. 11, 2012

(54) Label with Detachable Voltage Indicator and Battery Package Containing the Same

(75) Inventors: Barron G. McKillip, Mickleton, NJ (US); Ulrich E. Weyermann, Bethany Beach, DE (US); Edward Wiegand, Philadephia, PA (US); Barry Hostetter, Landenberg, PA (US)

(73) Assignee: Sancoa International Company, L.P., Lumberton, NJ (US)

(21) Appl. No.: 13/435,860

(22) Filed: Mar. 30, 2012

Related U.S. Application Data
(60) Provisional application No. 61/469,334, filed on Mar. 30, 2011.

(51) Int. Cl. G09F 3/00; B65D 85/00

(52) U.S. Cl. 206/703; 428/43

(57) ABSTRACT

The present invention provides an adhesive label in which a consumer item or device, such as a battery tester strip is printed in web form and is bonded to a consumer package.

### INTRODUCTION

This application claims the benefit of priority of U.S. Provisional Application No. 61/469,334, filed Mar. 30, 2011, which is herein incorporated by reference in its entirety.

### BACKGROUND OF THE INVENTION

Battery testers in the form of a flat sheet and including liquid crystal materials as visual indicators are known. U.S. Pat. No. 3,667,039 discloses a device which has a liquid crystal material contained within a rigid housing. One embodiment measures voltage by establishing an electric field gradient across the liquid crystal material. Another embodiment measures current by detecting a change in temperature. These designs are far more complicated in construction than the design of the present invention and would be too costly to incorporate into a package used for commercially marketing batteries. Similarly, U.S. Pat. No. 4,006,414 discloses a voltage or current indicating device which is simply constructed. U.S. Pat. Nos. 4,702,563 and 4,702,564 disclose a battery tester of the type described in U.S. Pat. No. 4,006,414. These inventions mount the voltage indicating device on a flexible transparent substrate. The resistive element through which current passes when connected to the terminals of a battery is bow-tie shaped and is mounted on one side of the flexible substrate. The liquid crystal material is deposited on the substrate side opposite to the bow-tie shaped element so as to be coincident therewith. The flexible character of the substrate permits it to be bent around a variety of cylindrical battery sizes in order to contact terminals located on opposite ends of the battery. U.S. Pat. No. 4,726,661 discloses a battery tester which operates in a manner similar but is designed to facilitate testing of small button-type batteries.

U.S. Pat. No. 4,723,656 discloses a package for the sale and display of batteries which has a voltage indicator integrally associated with the package. A pair of electrical contacts is located on the package for alignment with the terminals of a battery placed therebetween. However, the entire blister-portion of the package must be saved for future use of the voltage indicator. To address this, U.S. Pat. No. 5,188,231 describes a package for the sale and display of batteries, wherein a removable voltage tester is associated with the package.

Referring to FIGS. 1A-1C, conventional battery voltage indicators include a special compartment thermally molded into the plastic component of the packaging (FIG. 1A). During the forming process, a separate individual battery tester is placed into the thermally formed compartment (FIGS. 1B and 1C). To use the tester, the consumer must remove the tester pocket from the packaging and place the battery in the tester pocket (FIG. 1D). However, once the tester pocket is removed it cannot be restored on the packaging. Conventional construction of battery testers is often expensive to manufacture due to the manufacturing and material handling requirements of such a small component. The packaging lines need special pick and place equipment to insert the tester strips on packaging film during the forming process.

### SUMMARY OF THE INVENTION

The present invention is a label composed of a first edge region having an underside suitable for adhesion to a substrate; a second edge region having an underside suitable for adhesion to a substrate; and a centerpiece region with a consumer item or device, wherein the centerpiece region is removably coupled to the first and second edge regions. In some embodiments, the label further includes a release liner and the first and/or second edge region are decorated. In another embodiment, the centerpiece region is removably coupled to the first and second edge regions by perforations. In still another embodiment, the central portions of the first edge region and second edge region lack adhesive. In yet another embodiment, the consumer item or device is a battery tester, utensil, precision applicator, temperature indicator, feeler gauge or writing implement. A battery package containing the label of the invention is also provided.

### BRIEF DESCRIPTION OF THE DRAWINGS

FIG. 1A is an example of a prior art method of incorporating the tester strip with the packaging. The tester strip is individually placed on the packaging film during the thermo forming process. A tester pocket is formed incorporating the tester strip.

FIG. 1B shows the prior art tester pocket with tester strip removed from the packaging. This methodology requires that the battery tester strip be manufactured as individual components so that they can later be placed one by one in the vacuum forming apparatus that creates the holder.

FIG. 1C shows a prior art tester pocket with tester strip and battery inserted. To use, the consumer removes the holder from the packaging, places the battery into the holder and presses both ends against the battery. The heat generated from the current traveling through the conductive inks activates the thermo chromic inks in turn revealing the amount of current left in the battery.

FIG. 2A is an illustration of the back side of the instant tester strip label.

FIG. 2B is an illustration of the instant label construction, which combines the tester strip and storage unit.

FIG. 3 is a cross sectional end-view of assembly of the label with a battery package.

FIG. 4A illustrates the application of the instant label on a battery package.

FIG. 4B illustrates the instant battery tester and storage unit in which the tester has been removed from the label assembly and placed in the storage unit.

FIG. 4C is a cross sectional side-view of assembly of the label and battery package showing the on-pack holder for the battery tester.

FIG. 5 is an illustration of the combination tester strip and storage unit on a release liner previous to being applied to the battery packaging.

FIG. 6A is an illustration of the instant label construction, which shows three removable toothpicks in the centerpiece region.

FIG. 6B is an illustration of the instant label construction, which shows a removable precision applicator in the centerpiece region.

FIG. 6C is an illustration of the instant label construction, which shows a temperature indicator in the centerpiece region.

FIG. 6D is an illustration of the instant label construction, which shows a removable feeler gauge in the centerpiece region.

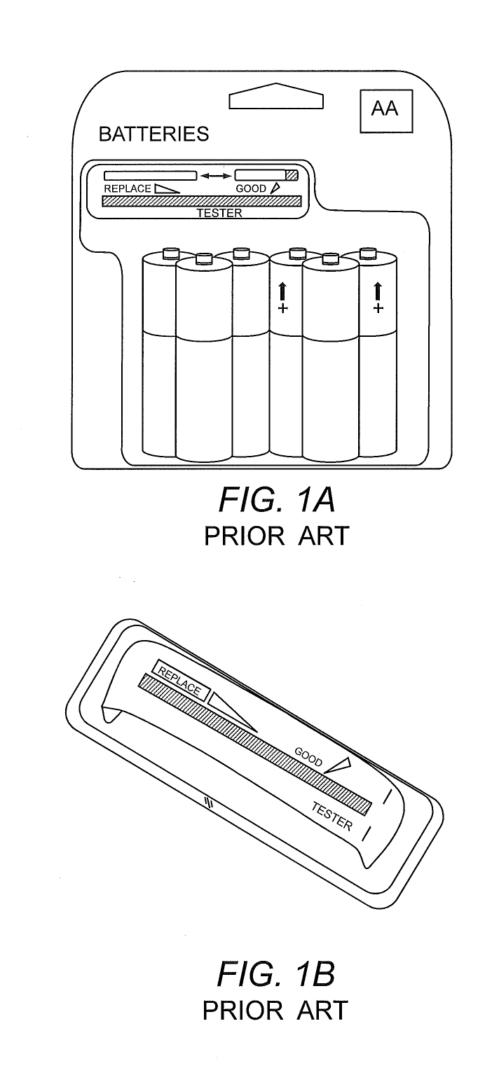

### DETAILED DESCRIPTION OF THE INVENTION

The present invention features the delivery of a consumer item or device via a label, which combines a removably coupled strip harboring the consumer item or device and optional storage compartment, wherein the label is printed in web form and is pattern adhesive bonded to a pattern slit pressure sensitive material. The combined label with removably coupled strip and pattern slit pressure sensitive label are then die cut to size and supplied in roll form for automatic application to packaging materials.

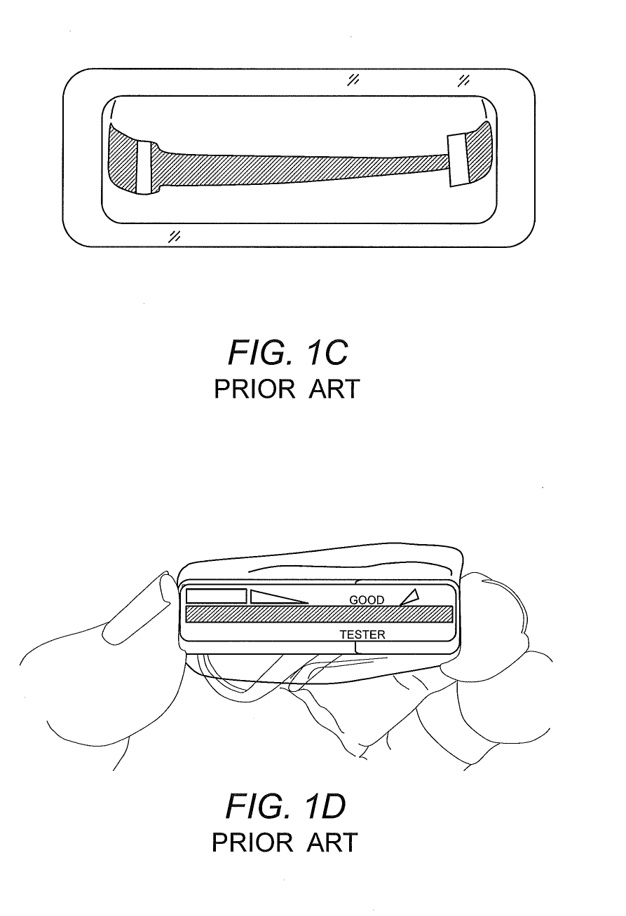

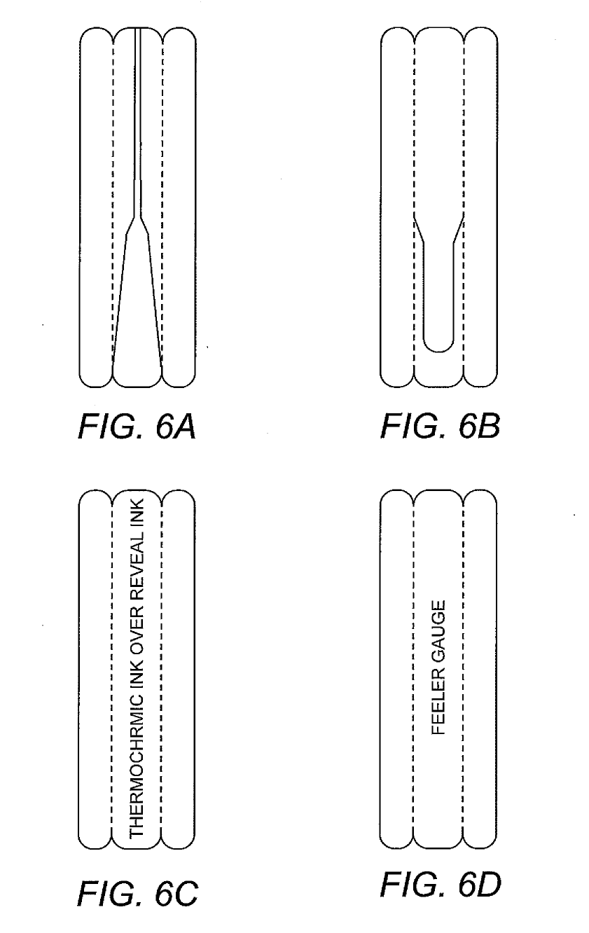

The instant invention embraces any consumer item or device that can be affixed or incorporated into a label. Particular consumer items or devices that can be delivered and optionally stored via the instant label include, but are not limited to, a battery tester on a battery or battery package (FIGS. 2-5); a utensil (e.g., a knife, spoon, fork, toothpick, straw, or spork) on a food package (FIG. 6A); a precision applicator (FIG. 6B), e.g., a makeup applicator on a makeup package; a temperature indicator (FIG. 6C), e.g., on wine bottle, beer container, a baby food jar or on a baby shampoo bottle for determining the temperature of bath water; a feeler gauge (FIG. 6D); and writing implement such as a pencil or pen on a writing tablet. In accordance with the present invention, the consumer item or device can be directly printed onto the removably coupled strip, releasable from said strip (i.e., the utensil is temporarily affixed to the underside of the strip), or is encased in said strip (e.g., the strip forms a pouch).

The following disclosure describes the instant invention using a battery tester as a specific example of the consumer item or device. However, as the skilled artisan will appreciate, this disclosure is applicable to any consumer item or device.

With reference to FIG. 2A, the instant label 10 is composed of a first edge region 20a having an underside 22a suitable for adhesion to a substrate; a second edge region 20b having an underside 22b suitable for adhesion to a substrate; and a centerpiece region 30 having a consumer item or device, e.g., a battery tester 40. The first and second edge regions (20a, 20b) and centerpiece region 30 are removably coupled so that centerpiece region 30 can be separated or detached from the first and second edge regions (20a, 20b). The first and second regions (20a, 20b) traverse the length of the label 10, running parallel along two peripheral boundaries of the label 10. Moreover, as it pertains to a battery tester, first and second regions (20a, 20b) can be of approximately equivalent length to the centerpiece region 30 and extend parallel to the axis of the battery tester 40.

As depicted in FIG. 2B, the first and second regions (20a, 20b) each have a first side (26a, 26b) and second side (27a, 27b), wherein the first side (26a, 26b) of each of the first and second edge regions (20a, 20b) borders the sides (32) of the centerpiece region 30. First and second edge regions (20a, 20b) also have opposing ends (28a, 28b). First and second edge regions can be printed or unprinted. In certain embodiments, the first and second edge regions are decorated, e.g., printed with text (e.g., product information or instructions) or graphics. The first and second edge regions (20a, 20b) are coupled securely to a substrate (e.g., a battery package or battery) by a suitable adhesive.

In some embodiments, the three regions (20a, 20b, 30) are defined by two rows of perforations (24a, 24b) that transect the label 10. In accordance with this embodiment, the perforations traverse the length of the label, are parallel to the battery tester, and are at a position approximately equal to the interface between the printed battery tester and the first and second edge regions (20a, 20b). By grasping and pulling the centerpiece region 30, one is able to tear the rows of perforations (24a, 24b) that couple the centerpiece region 30 to the first and second edge regions (20a, 20b) thereby removing the centerpiece region 30 from the label 10.

In another embodiment of this invention the label 10 is constructed with modified perforation schemes or designs. A perforation row typically includes weakened or fully-perforated perforations that alternate with intact or “tie” portions that provide the primary or total resistance to separation along the perforation row. The ratio of the length of perforations in a row to the length of tie portions in the row represents what is commonly known as the “cut-to-tie ratio.” The cut-to-tie ratio can be manipulated to affect the ease with which the perforations are burst at any particular point along the row of perforations. In one embodiment of the present invention the cut-to-tie ratio varies along the length of the rows of perforations that separate the centerpiece from the label. Such variation causes a row of perforations to tear most readily in the middle of the row, and to tear least readily at the ends of the row.

The removable consumer item or device of the instant label achieves tear-free and wrinkle-free separation of the centerpiece region from the label by allowing one to decouple the centerpiece region from the label in one step. However, it will be apparent to those skilled in the art that a consumer item or device that is coupled to a label at more than one edge can be decoupled from the edges one after the other by means other than a removable strip. One such means, for instance, would be a string that is transposed between plies at the juncture of the consumer item or device to the label which, when pulled, would tear through the second ply and thereby decouple the consumer item or device from the label at one edge. The present invention is meant to encompass all such means by which a consumer item or device can be decoupled from the adhered label.

As used herein, a “battery tester” is an individual battery “voltage” tester that can be manually used with individual batteries (e.g., alkaline batteries) to indicate the residual service life. The battery tester is produced from plastic (e.g., polyethylene terephthalate film), paper or a combination thereof, where battery tester components are designed for thermo chromic or electro chromic technologies. Battery tester components include conductive inks, resistive inks, thermo chromic inks, electro chromic inks, dielectric inks, conventional graphics inks, and adhesives. See, e.g., U.S. Pat. Nos. 4,723,656 and 5,188,231. Typical dimensions are related to the size of the battery but for example an AA size battery would have a battery tester in the range of 2.75 inches in length and 0.375 inches in width. Other typical sizes for AAA, A C and D size batteries are known in the art.

By way of illustration, the battery tester 40, when viewed from the underside (FIG. 2A), is composed of conductive ink 42, resistive ink 44 and a dielectric 46. When battery tester 40 is viewed from the upperside (FIG. 2B), the thermo chromic ink 48 is visible and becomes transparent when current is applied to the negative (−) and positive (+) sections of the battery tester 40.

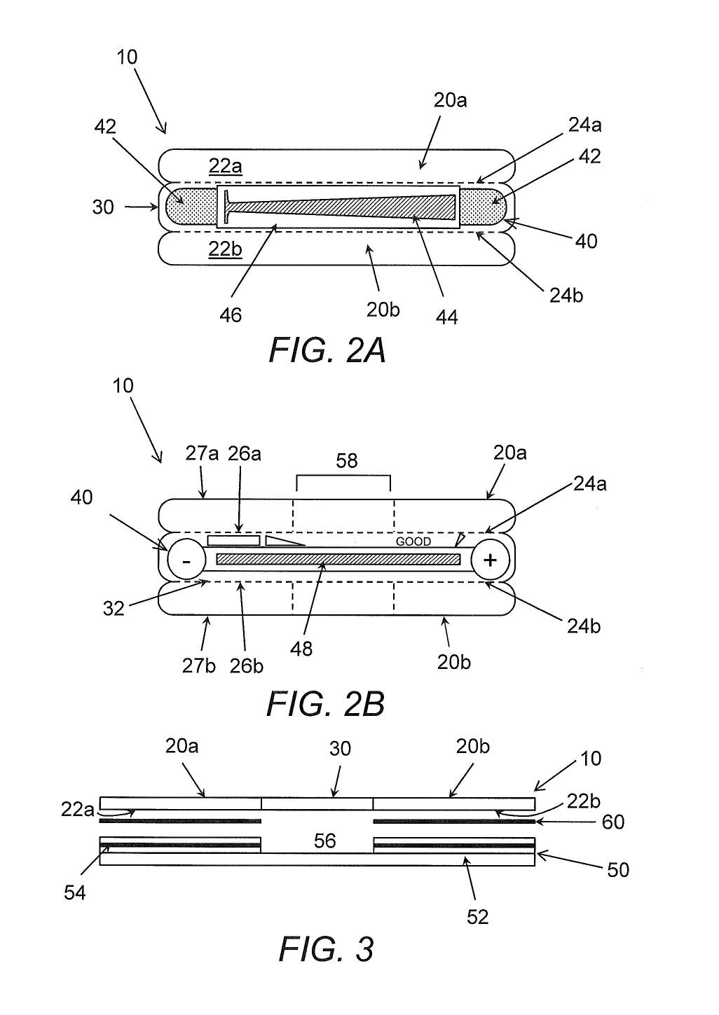

For application to a consumer package 50, an adhesive 60 is applied to the underside (22a, 22b) of the first and second edge regions (20a, 20b) of the label 10 (FIG. 3). The label may be applied by a separate adhesive application process by use of aqueous-based, solvent-based or 100% curable adhesives. The label may also be applied using a pressure sensitive label approach which employs a pre-applied pressure sensitive adhesive to the label and use of a release liner. Using the pressure sensitive label approach, a pressure sensitive adhesive 54 is applied to the outer surface of the paper board portion 52 of the consumer package 50 only where the first and second edge regions (20a, 20b) of the label 10 will be in contact with the consumer package 50. More particularly, the pressure sensitive adhesive 54 is applied to only the opposing ends (28a, 28b) of the first and second edge regions (20a, 20b) thereby resulting in an adhesive-free central band 56 that is of a size capable of housing the centerpiece region 30 of the label 10. Specifically, the band 56 lacking adhesive is of a width at least equal to or greater than the width of the centerpiece region 30 of the label 10.

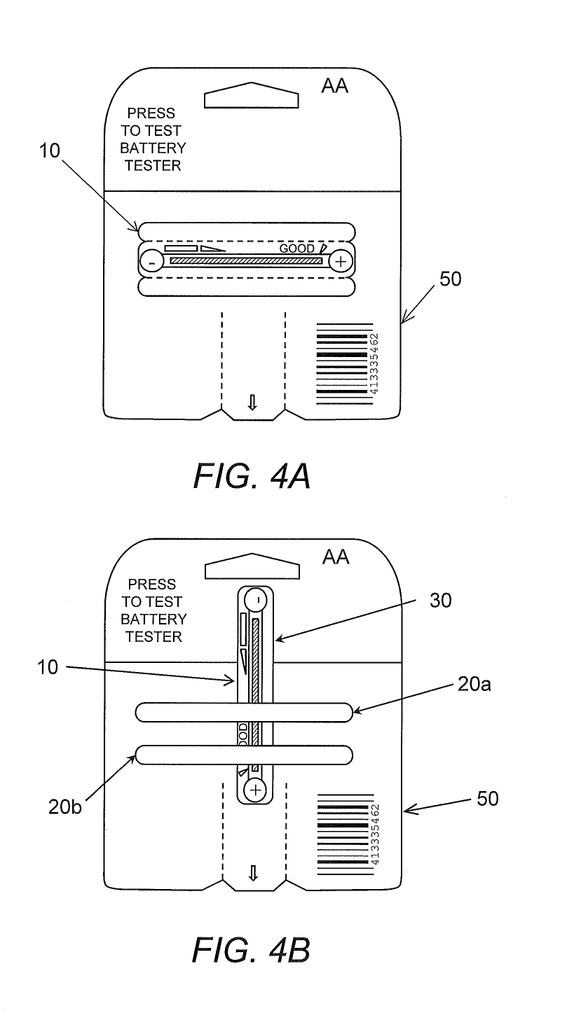

After application of the label to the paper board portion of the battery package (FIG. 4A), the center region containing the battery tester is easily removed from the label by tearing of the perforation (FIG. 4B). The resultant centerpiece region provides a “free” individual battery tester with the first and second edge regions remaining adhered to the paper board portion of the battery package.

In another embodiment of the invention, the label 10 can include a design which provides an on-pack holder for centerpiece region 30 containing the consumer item or device after it is removed from first and second edge regions (20a, 20b) of the label 10. As illustrated in FIG. 4B, a tester strip is printed in web form and is pattern adhesive-bonded to a pattern slit pressure sensitive material. The combined label with tester strip and pattern slit pressure sensitive label are then die cut to size. As illustrated in FIG. 4C, the on-pack holder 70 is produced with selective application of the pressure sensitive adhesives 60, 54 on the first and second edge regions (20) of the label 10 and the paper board portion 52 of the battery package 50. Alignment of the adhesives 60, 54 creates a space 58 approximately equal in width to the battery tester (FIG. 2B, FIG. 4C), thereby providing for a slot for sliding the battery tester in and holding the battery tester with the battery pack for future use (FIG. 4B).

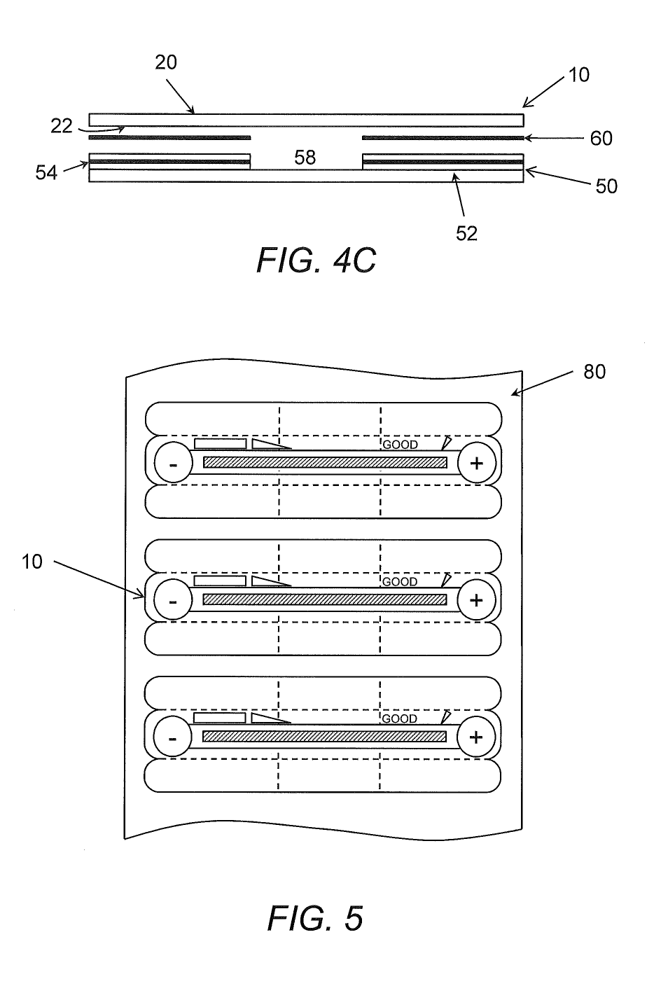

The label of the invention can be produced using conventional label printing machinery. When produced as a pressure-sensitive adhesive label, label 10 can be provided with release liner 80 (e.g., a silicone release liner) in roll form for subsequent, automatic application to multiple consumer packages (FIG. 5).

The instant label containing a battery tester can be included in a multi-pack of alkaline batteries where the battery tester includes the features of easy pack removal, low cost manufacturing and incorporation into the multi-pack assembly with or without an on-pack holding device. With regard to embodiments pertaining to a battery tester, the present invention overcomes problems associated with conventional battery voltage indicators by eliminating the thermally formed tester pocket and combining the tester strip with a specially designed pressure sensitive label that allows the consumer to store the tester strip on the packaging after use.

What is claimed is:

1. A label comprising:
a) a first edge region having an underside suitable for adhesion to a substrate;
b) a second edge region having an underside suitable for adhesion to a substrate; and
c) a centerpiece region comprising a consumer item or device, wherein the centerpiece region is removably coupled to the first and second edge regions.

2. The label of claim 1, further comprising a release liner.

3. The label of claim 1, wherein the centerpiece region is removably coupled to the first and second edge regions by perforations.

4. The label of claim 1, wherein the central portion of the first edge region and second edge region lack adhesive.

5. The label of claim 1, wherein the first edge region, second edge region, or combination thereof is decorated.

6. The label of claim 1, wherein the consumer item or device is a battery tester, utensil, precision applicator, temperature indicator, feeler gauge or writing implement.

7. A label comprising:
a) a first edge region having an underside suitable for adhesion to a substrate;
b) a second edge region having an underside suitable for adhesion to a substrate; and
c) a centerpiece region comprising a battery tester, wherein the centerpiece region is removably coupled to the first and second edge regions.

8. The label of claim 7, further comprising a release liner.

9. The label of claim 7, wherein the centerpiece region is removably coupled to the first and second edge regions by perforations.

10. The label of claim 7, wherein the central portion of the first edge region and second edge region lack adhesive.

11. The label of claim 7, wherein the first edge region, second edge region, or combination thereof is decorated.

12. A battery package comprising the label of claim 7.
